(19) United States
(12) Patent Application Publication
(10) Pub. No.: US 2012/0242657 A1
(43) Pub. Date: Sep. 27, 2012

(54) DISPLAY APPARATUS

(75) Inventors: Mitsuyasu Asano, Tokyo (JP); Kenta Makimoto, Tokyo (JP); Ken Kikuchi, Tokyo (JP)

(73) Assignee: SONY CORPORATION, Tokyo (JP)

(21) Appl. No.: 13/418,806

(22) Filed: Mar. 13, 2012

(30) Foreign Application Priority Data
Mar. 22, 2011 (JP) 2011-062082

(51) Int. Cl. G06T 15/00

(52) U.S. Cl. 345/419

(57) ABSTRACT

A display apparatus includes: a display unit that displays an image; an image signal processing unit that divides each of left-eye and right-eye images input in accordance with a frame sequential format into an upper-half signal of a screen upper portion and a lower-half signal of a screen lower portion and generates left-eye and right-eye images of the frame sequential format in upper and lower division simultaneous driving of a screen of the display unit so that the upper-half signal of the left-eye image and the lower-half signal of the right-eye image at each time become an input image at an identical time; and a driving control unit that vertically divides the screen of the display unit into two portions and simultaneously drives the screen upper portion and the screen lower portion to display the left-eye and the right-eye images processed by the image signal processing unit.

### CROSS-REFERENCE TO RELATED APPLICATION

The present application claims priority from Japanese Patent Application No. JP 2011-062082, filed in the Japanese Patent Office on Mar. 22, 2011, the entire content of which is incorporated herein by reference.

### BACKGROUND

The present disclosure relates to a display apparatus displaying a stereoscopic image, and more particularly, to a display apparatus displaying an image viewed stereoscopically in accordance with a frame sequential format of inserting left-eye and right-eye image frames one by one in a time division manner.

A stereoscopic image which can stereoscopically be viewed can be exhibited to viewers by displaying an image with parallax between the right and left eyes of the viewers. A stereoscopic view technology is expected to be applied to various fields such as television broadcasting, movies, remote communication, or remote medical care.

For example, a time-division stereoscopic viewing image display system includes a display apparatus that displays a plurality of different images in a time division manner and shutter glasses that a viewer wears. The display apparatus alternately displays left-eye and right-eye images with parallax in a very short time on a screen. On the other hand, the shutter glasses that the viewer wears include a shutter mechanism that includes liquid crystal lenses for left-eye and right-eye sections. The left-eye section of the shutter glasses transmits light and the right-eye section of the shutter glasses blocks light, while a left-eye image is being displayed. Further, the right-eye section of the shutter glasses transmits light and the left-eye section of the shutter glasses blocks light, while a right-eye image is being displayed (for example, see Japanese Unexamined Patent Application Publication Nos. 9-138384, 2000-36969, and 2003-45343). That is, a stereoscopic image is exhibited to the viewers by displaying the left-eye image and the right-eye image in the time division manner by the display apparatus and selecting the image in synchronization with the switching of the display by the display apparatus using the shutter mechanism.

As a transmission format of signals of the stereoscopic image, there is known a “frame sequential (or field sequential)” format of inserting left-eye image frames and right-eye image frames one by one in the time-division manner within one vertical blanking component.

For example, a liquid crystal display (LCD) is used in the display apparatus that displays a stereoscopic image. In general, an active matrix type liquid crystal display is used in which a TFT (Thin Film Transistor) is disposed in each pixel. The TFT liquid crystal display executes a display process by writing image signals to scanning lines from the upper portion of a screen to the lower portion of the screen to drive respective pixels and blocking light emitted from a backlight from the respective pixels or transmitting the light through the respective pixels.

In the case of the liquid crystal display, a display response speed is delayed since it takes some time to discharge the liquid crystal. With an increase in the size of the display panel, the problem of the display speed is more serious. As one of the methods of improving the display speed, there is a method of dividing the display panel into two portions, that is, upper and lower portions and simultaneously controlling display of the upper and lower portions (for example, see Japanese Unexamined Patent Application Publication No. 2007-20022).

Even when a stereoscopic image is displayed in accordance with the frame sequential format, the display speed can be considered to be improved by dividing the liquid crystal panel into two portions and driving the two portions.

However, when the method of dividing the liquid crystal panel into two portions and driving the two portions is simply applied in the display of the stereoscopic image, there is a concern that a localized position is different in a depth direction between the upper and lower portions of a screen. For example, an image may have a sense of considerable incompatibility since the upper portion of the screen appears to be far away and the lower portion of the screen appears to be up close.

### SUMMARY

It is desirable to provide an excellent display apparatus capable of appropriately displaying a stereoscopic image in accordance with a frame sequential format of inserting left-eye image frames and right-eye image frames one by one in a time division manner.

It is desirable to also provide an excellent display apparatus capable of appropriately displaying a stereoscopic image in accordance with the frame sequential format while improving a display speed by dividing a display screen into two upper and lower portions and simultaneously driving the upper and lower portions.

According to an embodiment of the present disclosure, there is provided a display apparatus including: a display unit that displays an image; an image signal processing unit that divides each of left-eye and right-eye images input in accordance with a frame sequential format into an upper-half signal of a screen upper portion and a lower-half signal of a screen lower portion and generates left-eye and right-eye images of the frame sequential format in upper and lower division simultaneous driving of a screen of the display unit so that the upper-half signal of the left-eye image and the lower-half signal of the right-eye image at each time become an input image at an identical time; and a driving control unit that vertically divides the screen of the display unit into two portions and simultaneously drives the screen upper portion and the screen lower portion to display the left-eye and the right-eye images processed by the image signal processing unit.

In the display apparatus according to the embodiment of the present disclosure, the image signal processing unit may sequentially generate a left-eye image L′n of an n-th frame, which includes the screen upper portion of an input left-eye image Ln at the identical time and the screen lower portion of a left-eye interpolated image L(n−0.5) at a time before a 0.5 frame, and a right-eye image R′n of the n-th frame, which includes the screen upper portion of a right-eye interpolated image R(n+0.5) at the time after a 0.5 frame and the screen lower portion of an input right-eye image Rn at the identical time, in the upper and lower division simultaneous driving.

In the display apparatus according to the embodiment of the present disclosure, the image signal processing unit may sequentially generate a left-eye image L′n of an n-th frame, which includes the screen upper portion of a left-eye interpolated image L(n−0.5) at a time before a 0.5 frame and the screen lower portion of an input left-eye image L(n−1) at a time before one frame, in the upper and lower division simultaneous driving and a right-eye image R′n of the n-th frame, which includes the screen upper portion of an input right-eye image Rn at the identical time and the screen lower portion of a right-eye interpolated image R(n−0.5) at the time before a 0.5 frame, in the upper and lower division simultaneous driving.

According to another embodiment of the present disclosure, there is provided a display apparatus including: a display unit that displays an image; an image signal processing unit that vertically divides a screen of each of left-eye and right-eye images input in accordance with a frame sequential format into N 1/N signals (where, N is an integer equal to or greater than 2) and generates left-eye and right-eye images at respective times configured by the 1/N signal at the identical time and (N−1) interpolated images of which a time is deviated by k/N frames at a position distant by k/N frames in a vertical direction of the screen; and a driving control unit that vertically divides the screen of the display unit into two portions and simultaneously drives the screen upper portion and the screen lower portion to display the left-eye and the right-eye images processed by the image signal processing unit.

According to the embodiments of the present disclosure, it is possible to provide an excellent display apparatus capable of appropriately displaying the stereoscopic image in accordance with the frame sequential format while improving the display speed by dividing the display screen into two upper and lower portions and simultaneously driving the upper and lower portions.

According to the embodiments of the present disclosure, it is possible to provide an excellent display apparatus capable of appropriately displaying the stereoscopic image in accordance with the frame sequential format, while keeping a low position in the depth direction in the screen upper portion and the screen lower portion in the upper and lower two-division simultaneous driving.

The other features and advantages of the embodiments of the present disclosure will be apparent from the detailed description of the embodiments of the present disclosure and the accompanying drawings described below.

### BRIEF DESCRIPTION OF THE DRAWINGS

FIG. 1 is a diagram illustrating a case where a stereoscopic image is displayed in a frame sequential format;

FIG. 2 is a diagram illustrating a case where a two-dimensional image is displayed by dividing a display screen into two portions and simultaneously driving the divided two portions;

FIG. 3 is a diagram illustrating a case where a stereoscopic image is displayed in accordance with the frame sequential format by simply applying an upper and lower two-division simultaneous driving method;

FIG. 4 is a diagram illustrating a display method of displaying a stereoscopic image suitable for the upper and lower two-division simultaneous driving method;

FIG. 5 is a diagram illustrating a case where the subject of a left-eye image is present on the right side of the subject of a right-eye image;

FIG. 6 is a diagram illustrating a case where the subjects of a left-eye image Ln and a right-eye image Rn are present at the identical position on a screen;

FIG. 7 is a diagram illustrating a case where the subject of a right-eye image is present on the right side of the subject of a left-eye image;

FIG. 8A is a diagram illustrating a case where viewers perceive a subject at the front of a display panel when the subject of a left-eye image is present on the right side of the subject of a right-eye image;

FIG. 8B is a diagram illustrating a case where viewers perceive a subject on the surface of the display panel when the subject of a left-eye image and the subject of a right-eye image are present at the identical position;

FIG. 8C is a diagram illustrating a case where viewers perceive a subject at the rear of a display panel when the subject of a right-eye image is present on the right side of the subject of a left-eye image;

FIG. 9 is a diagram illustrating a case where a subject is moving from the left side to the right side over time;

FIG. 10A is a diagram illustrating a case where the stereoscopic image of the subject moving from the left side to the right side is displayed in accordance with the method shown in FIG. 3;

FIG. 10B is an expanded diagram illustrating left-eye images and right-eye images of two frames in the upper and lower division simultaneous driving;

FIG. 11 is a diagram illustrating a case where a subject is moving from the right side to the left side over time;

FIG. 12A is a diagram illustrating a case where the stereoscopic image of the subject moving from the right side to the left side is displayed in accordance with the method shown in FIG. 3;

FIG. 12B is an expanded diagram illustrating left-eye images and right-eye images of two frames in the upper and lower division simultaneous driving;

FIG. 13A is a diagram illustrating a case where the stereoscopic image of the subject moving from the left side to the right side is displayed in accordance with the method shown in FIG. 4;

FIG. 13B is an expanded diagram illustrating left-eye images and right-eye images of two frames in the upper and lower division simultaneous driving;

FIG. 14A is a diagram illustrating a case where the stereoscopic image of the subject moving from the right side to the left side is displayed in accordance with the method shown in FIG. 4;

FIG. 14B is an expanded diagram illustrating left-eye images and right-eye images of two frames in the upper and lower division simultaneous driving;

FIG. 15 is a diagram illustrating a display method of displaying a stereoscopic image suitable for the upper and lower two-division simultaneous driving;

FIG. 16A is a diagram illustrating a case where the stereoscopic image of the subject moving from the left side to the right side is displayed in accordance with the method shown in FIG. 15;

FIG. 16B is an expanded diagram illustrating left-eye images and right-eye images of two frames in the upper and lower division simultaneous driving;

FIG. 17A is a diagram illustrating a case where the stereoscopic image of the subject moving from the right side to the left side is displayed in accordance with the method shown in FIG. 15;

FIG. 17B is an expanded diagram illustrating left-eye images and right-eye images of two frames in the upper and lower division simultaneous driving;

FIG. 18 is a diagram illustrating an example of the configuration of a display apparatus that displays a stereoscopic image in accordance with the upper and lower two-division simultaneous driving;

FIG. 19 is a diagram schematically illustrating the functional configuration of an image signal processing unit to realize the display method of the stereoscopic image in the upper and lower two-division simultaneous driving shown in FIG. 4; and

FIG. 20 is a diagram schematically illustrating the functional configuration of an image signal processing unit to realize the display method of the stereoscopic image in the upper and lower two-division simultaneous driving shown in FIG. 15.

### DETAILED DESCRIPTION OF EMBODIMENTS

Hereinafter, embodiments of the present disclosure will be described in detail with reference to the drawings.

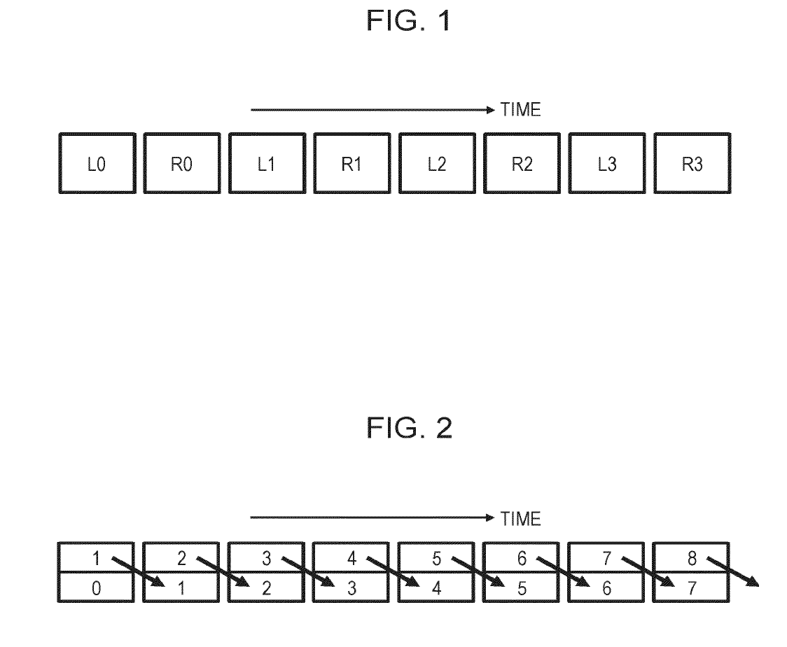

FIG. 1 is a diagram illustrating a case where a stereoscopic image is displayed in a frame sequential (or field sequential) format). As shown in the drawing, left-eye image frames and right-eye image frames are alternately displayed in a time division manner. In the drawing, “L” described in each frame indicates a left-eye image and “R” described in each frame indicates a right-eye image. A numeral attached to L and R indicates a sequence number of the frames, that is, a display order on a time axis. In the example shown in the drawing, the frames are displayed in the order of a left-eye image Ln and a right-eye image Rn at the identical time (where, n is a positive integer indicating the sequence number of the frame).

FIG. 2 is a diagram illustrating a case where a two-dimensional image is displayed by dividing a display screen into two portions and simultaneously driving the two divided portions. The numerals described in the frames in the drawing indicate a sequence number of the frames, that is, the display order on a time axis. As shown in the drawing, a lower screen signal is a signal prior to an upper screen signal by one frame time. When an input image is focused at a given time, the input image is first displayed on the screen upper portion, and then is displayed on the screen lower portion at the subsequent frame. In the drawing, a relation between the upper and lower images of an input image at the identical time is represented by a diagonal arrow. Accordingly, it has to be sufficiently understood that an upper image displayed at the current one frame and a lower image displayed at the subsequent frame is an input signal of the identical frame.

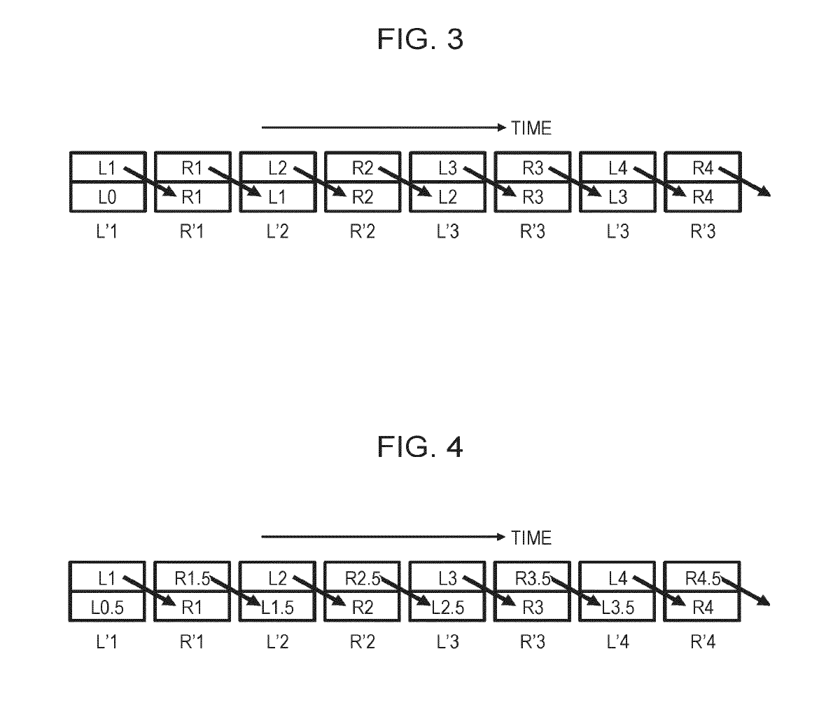

Here, when the display order of an upper and lower two-division simultaneous driving method of first displaying the upper image of an input at a given time and then displaying the lower image of the input image at the subsequent frame, as shown in FIG. 2, is simply applied to the display order in which the stereoscopic image is displayed in the order of the left-eye image Ln and the right-eye image Rn at the identical time, as shown in FIG. 1, the stereoscopic image is displayed, as shown in FIG. 3. In FIG. 3, in the upper and lower two-division simultaneous driving, a left-eye image L′n at an n-th frame includes the screen upper portion of an original left-eye image Ln at the identical time and the screen lower portion of an original left-eye image L(n−1) at the time before one frame. Further, a right-eye image R′n at an n-th frame includes the screen upper portion and the screen lower portion of an original right-eye image Rn at the identical time.

Here, when a display method of displaying the stereoscopic image shown in FIG. 3 is examined, frames are displayed in the order of the left-eye image Ln and the right-eye image Rn at the identical time, as in FIG. 1. Further, the screen upper portion of an input image at a given time is displayed, and then the screen lower portion of the input image is displayed at the subsequent frame, as in FIG. 2. In FIG. 3, a relation between the upper and lower images of the input image at the identical time is indicated by a diagonal arrow.

Each diagonal arrow indicating the relation between the upper and lower images of an input image at the identical time is drawn to the adjacent frame. In a time-division stereoscopic view display method, one of the two upper and lower images linked by a diagonal arrow is necessarily a left-eye image signal and the other thereof is necessarily a right-eye image signal. When a left-eye image and a right-eye image are precisely distinguished from each other, the upper and lower images linked by a diagonal arrow are not the same frame signal. However, considering only the numeral, that is, only a time, the upper and lower images linked by a diagonal arrow are the same frame signal.

The display method of displaying the stereoscopic image shown in FIG. 3 will be further examined in consideration of the display contents of an image.

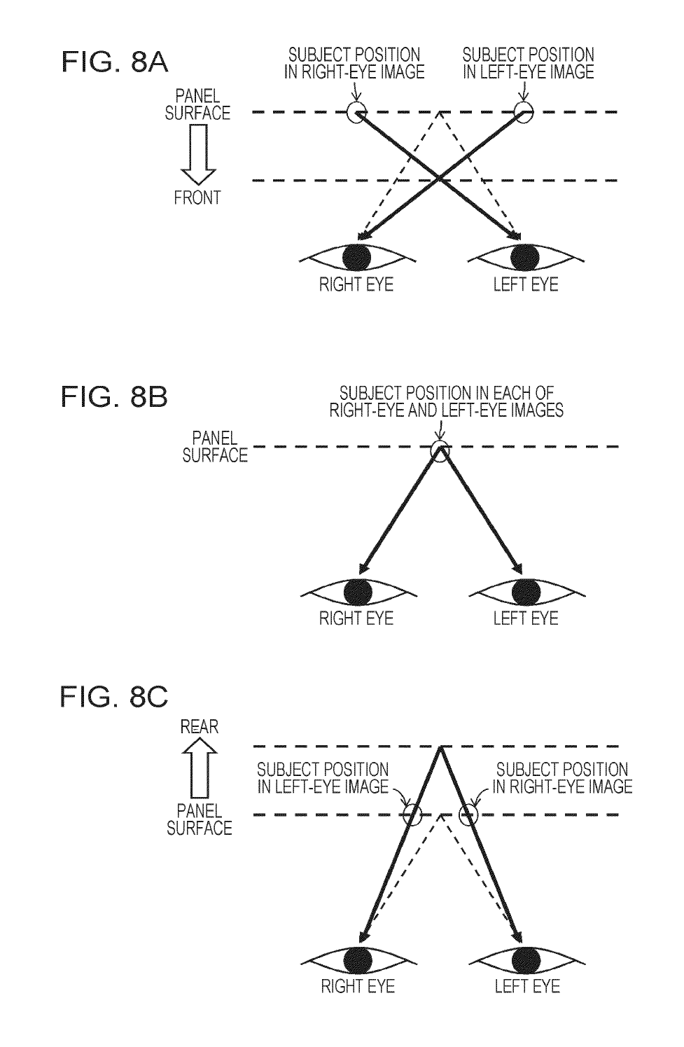

A subject localized at a position where there is neither protrusion nor recession has no parallax between left-eye and right-eye images. As shown in FIG. 8B, the subject corresponds to a subject perceived on the surface of the display panel. In this case, as shown in FIG. 6, in such a subject, a left-eye image Ln and a right-eye image Rn are present at the identical position on the screen, that is, Ln=Rn. As a result, as in FIG. 2, a relation is satisfied in which the upper image of an input image at a given time is displayed on the upper portion of a screen, and then the lower image of the input image is displayed on the lower portion of the screen.

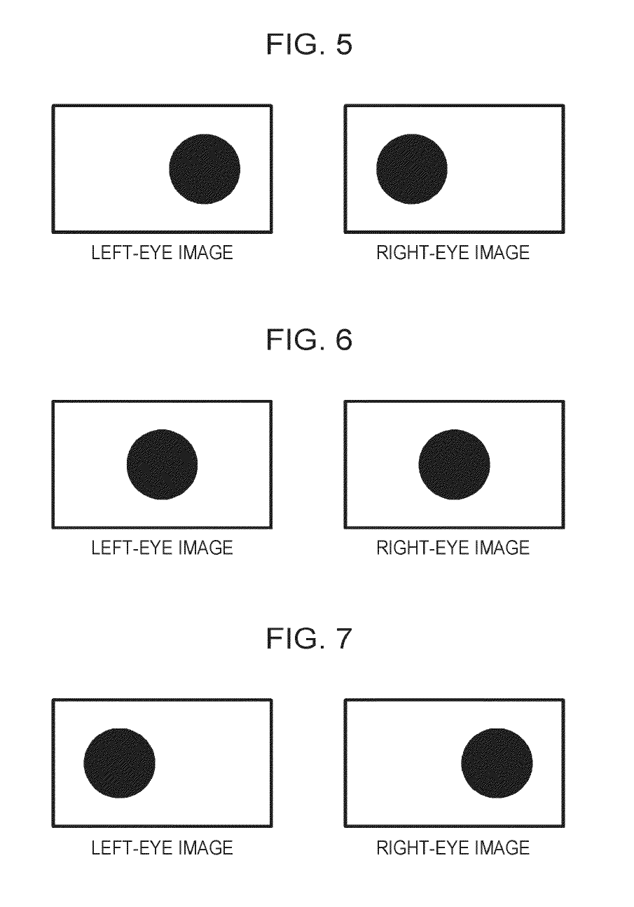

On the other hand, when a subject is perceived at the front of the display panel, as shown in FIG. 8A, the subject of the left-eye image is present on the right side of the subject of a right-eye image, as shown in FIG. 5. Conversely, when the subject of a left-eye image is present on the right side of the subject of a right-eye image, viewers perceive the subject at the front of the display panel.

Further, when viewers perceive the subject at the rear of the display panel, as shown in FIG. 8C, the subject of a right-eye image is present on the right side of the subject of a left-eye image, as shown in FIG. 7. Conversely, when the subject of a right-eye image is present on the right side of the subject of a left-eye image, viewers perceive the subject at the rear of the display panel.

In short, whether viewers of a stereoscopic image perceive a subject at the rear of a screen or at the front of the screen depends on a relation of the position of the subject localized on the screen (parallax given) between the left-eye image Ln and the right-eye image Rn at the identical time.

The display method of displaying the stereoscopic image shown in FIG. 3 will be further examined in consideration of the fact that viewers perceive the depth of the subject in accordance with the positions of the subject of a left-eye image and the subject of a right-eye image.

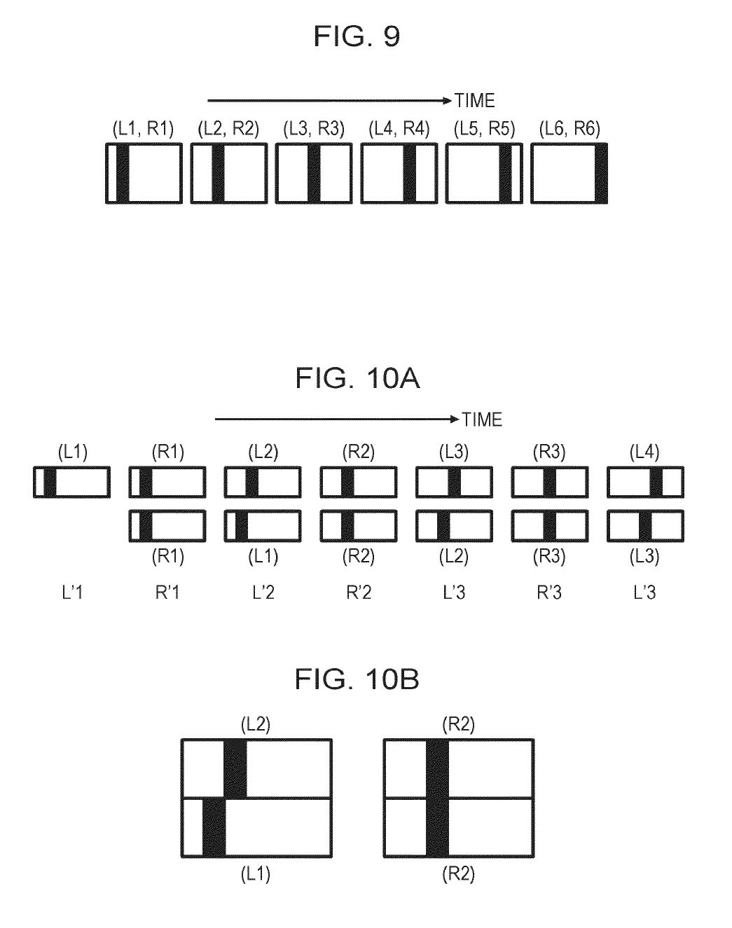

As shown in FIG. 9, a case will be described in which a subject is moving from the left side to the right side over time. Here, the subject is moving from the left side to the right side on the surface of the display panel and the subject of a left-eye image and the subject of a right-eye image are originally present at the identical position. FIG. 10A shows the subjects of the left-eye image and the right-eye image displayed in accordance with the display method of displaying the stereoscopic image shown in FIG. 3.

According to the display method shown in FIG. 3, in the upper and lower two-division simultaneous driving, a left-eye image L′n of an n-th frame includes a screen upper portion of an original left-eye image Ln at the identical time and a screen lower portion of an original left-eye image L(n−1) at the time before one frame. Further, a right-eye R′n of the n-th frame includes a screen upper portion and a screen lower portion of an original right-eye image Rn at the identical time (which is described above). When the left-eye image L′n and the right-eye image R′n are paired in the upper and lower two-division simultaneous driving in FIG. 10A, the subject of the left-eye image and the subject of the right-eye image are present at the identical position in the screen upper portion, whereas the subject of the left-eye image is present on the left side of the subject of the right-eye image in the screen lower portion. FIG. 10B is an expanded diagram illustrating the left-eye images and the right-eye images of two frames in the upper and lower division simultaneous driving. This means that the subject in the screen lower portion is localized at the rear side of the screen, as understood from the result shown in FIGS. 7 and 8C. That is, in the display method of displaying the stereoscopic image shown in FIG. 3, unevenness occurs in the depth direction between the upper and lower portions of the screen.

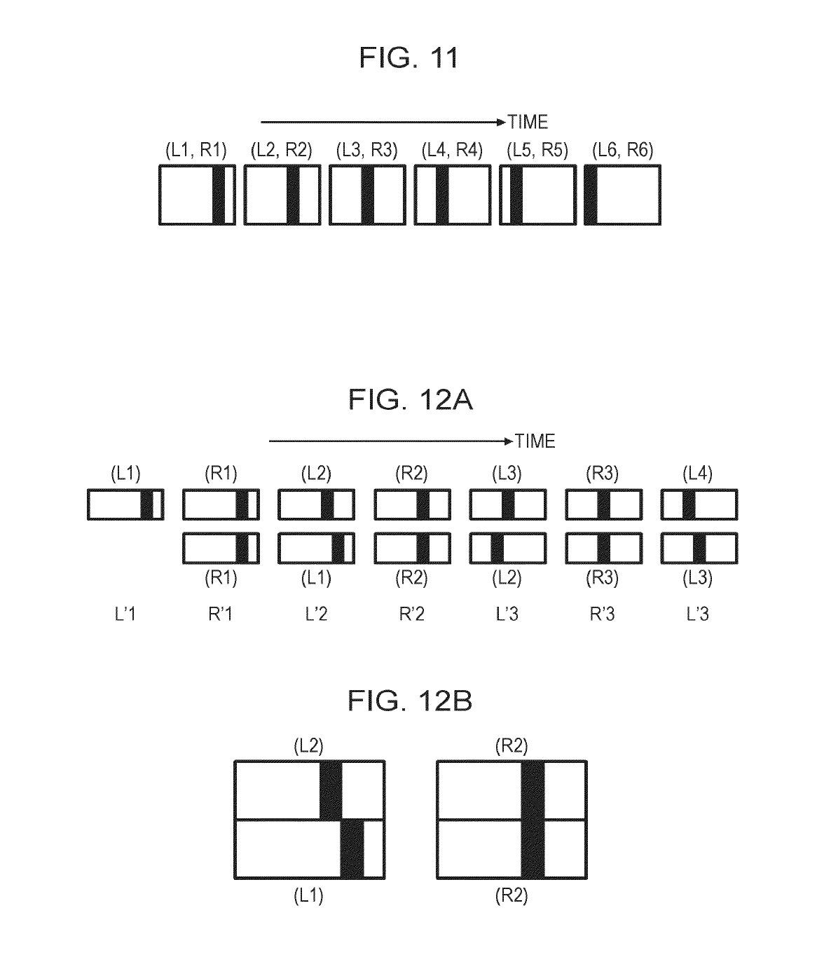

On the contrary, as shown in FIG. 11, a case will be described in which a subject is moving from the right side to the left side over time. Here, the subject is moving from the right side to the left side on the surface of the display panel and the subject of a left-eye image and the subject of a right-eye image are originally present at the identical position. FIG. 12A shows the subjects of the left-eye image and the right-eye image displayed in accordance with the display method of displaying the stereoscopic image shown in FIG. 3.

According to the display method shown in FIG. 3, in the upper and lower two-division simultaneous driving, a left-eye image L′n of an n-th frame includes a screen upper portion of an original left-eye image Ln at the identical time and a screen lower portion of an original left-eye image L(n−1) at the time before one frame. Further, a right-eye R′n of the n-th frame includes a screen upper portion and a screen lower portion of an original right-eye image Rn at the identical time (which is described above). When the left-eye image L′n and the right-eye image R′n are paired in the upper and lower two-division simultaneous driving in FIG. 12A, the subject of the left-eye image and the subject of the right-eye image are present at the identical position in the screen upper portion, whereas the subject of the left-eye image is present on the right side of the subject of the right-eye image in the screen lower portion. FIG. 12B is an expanded diagram illustrating the left-eye images and the right-eye images of two frames in the upper and lower division simultaneous driving. This means that the subject in the screen lower portion is localized at the front side of the screen, as understood from the result shown in FIGS. 5 and 8A. That is, in the display method of displaying the stereoscopic image shown in FIG. 3, unevenness occurs in the depth direction between the upper and lower portions of the screen.

Accordingly, the inventors suggest a display method of displaying a stereoscopic image in the upper and lower two-division driving in FIG. 4 instead of the display method shown in FIG. 3. According to the display method shown in FIG. 4, in the screen upper portion, 0.5 is added to the sequence number n of the frame for the right-eye image R. In the screen lower portion, 0.5 is added to the sequence number n of the frame for the left-eye image L in comparison to the display method shown in FIG. 3. Accordingly, in the upper and lower two-division driving, a left-eye image L′n of an n-th frame includes a screen upper portion of an original left-eye image Ln at the identical time and a screen lower portion of a left-eye interpolated image L(n−0.5) at the time before 0.5 frame. Further, a right-eye image R′n of the n-th frame includes a screen upper portion of a right-eye interpolated image R(n+0.5) at the time after 0.5 frame and a screen lower portion of an original right-eye image Rn at the identical time. According to the display method shown in FIG. 4, the upper image of an input image at a given time is first displayed, and then the lower image of the input image is displayed in the subsequent frame, as in the upper and lower two-division simultaneous driving method shown in FIG. 2. Here, L(n+0.5) is a left-eye interpolated image which is interpolated temporally almost in the center between the left-eye image Ln of the n-th frame and the left-eye image L(n+1) of the (n+1)-th frame. The same is applied to the right-eye interpolated image R(n+0.5).

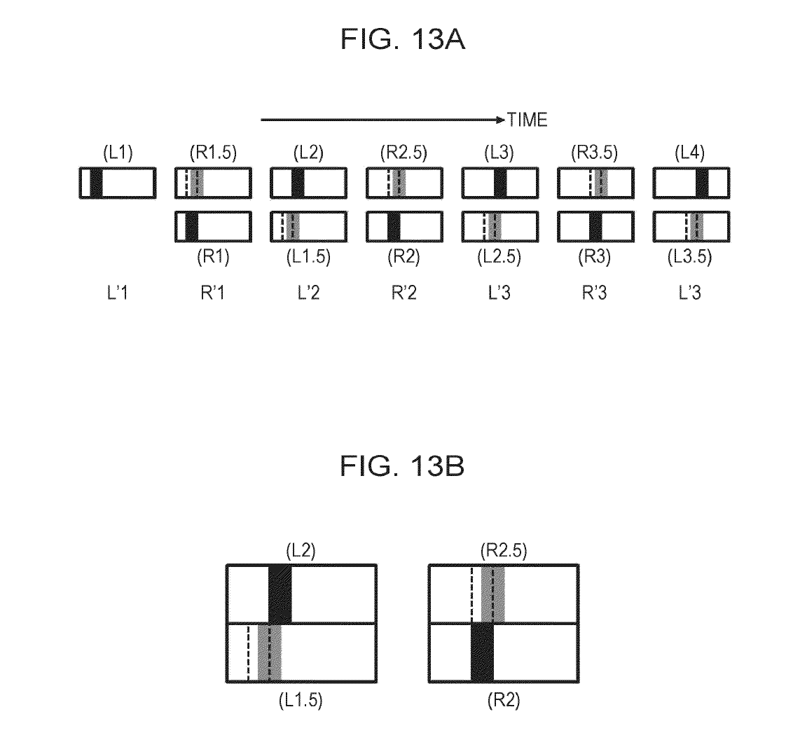

As shown in FIG. 9, the case will be described in which a subject is moving from the left side to the right side over time. Here, the subject is moving from the left side to the right side on the surface of the display panel and the subject of a left-eye image and the subject of a right-eye image are originally present at the identical position (which is described above). FIG. 13A shows the subjects of the left-eye image and the right-eye image displayed in accordance with the display method of displaying the stereoscopic image shown in FIG. 4.

According to the display method shown in FIG. 4, in the upper and lower two-division simultaneous driving, a left-eye image L′n of an n-th frame includes the screen upper portion of an original left-eye image Ln at the identical time and the screen lower portion of a left-eye interpolated image L(n−0.5) at the time before 0.5 frame. Further, a right-eye image R′n of an n-th frame includes the screen upper portion of a right-eye interpolated image R(n+0.5) at the time after 0.5 frame and the screen lower portion of an original right-eye image Rn at the identical time. In FIG. 13A, the subjects of the input images Ln and Rn are indicated by black and the subjects of the interpolated images L(n−0.5) and R(n+0.5) are indicated by gray. The subjects shown in FIG. 10A are indicated by a dashed line to make a comparison.

When the left-eye image L′n and the right-eye image R′n are paired in the upper and lower two-division simultaneous driving in FIG. 13A, a relative position relation is the same between the subjects of the left-eye image and the right-eye image without dependence on the screen upper portion and the screen lower portion. FIG. 13B is an expanded diagram illustrating the left-eye images and the right-eye images of two frames in the upper and lower division simultaneous driving. This means that the subject in the screen upper portion and the subject in the screen lower portion is localized in the identical depth direction, as understood from the result shown in FIGS. 6 and 8B. Accordingly, the unevenness shown in FIG. 10A does not occur in the depth direction between the upper and lower portions of the screen.

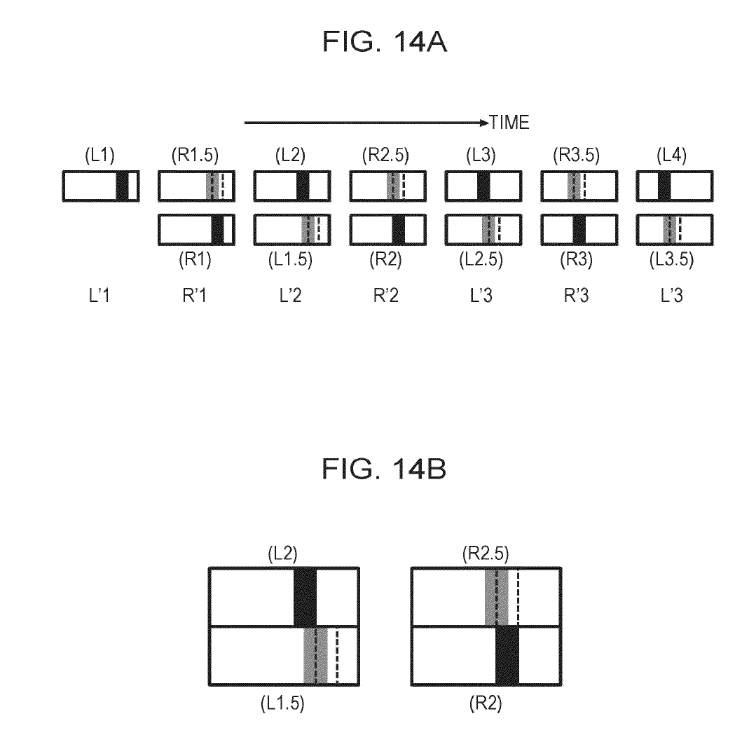

Subsequently, as shown in FIG. 11, the case will be described in which a subject is moving from the right side to the left side over time. Here, the subject is moving from the left side to the right side on the surface of the display panel and the subject of a left-eye image and the subject of a right-eye image are originally present at the identical position (which is described above). FIG. 14A shows the subjects of the left-eye image and the right-eye image displayed in accordance with the display method of displaying the stereoscopic image shown in FIG. 4. In FIG. 14A, the subjects of the input images Ln and Rn are indicated by black and the subjects of the interpolated images L(n−0.5) and R(n+0.5) are indicated by gray. The subjects shown in FIG. 12A are indicated by a dashed line to make a comparison.

When the left-eye image L′n and the right-eye image R′n are paired in the upper and lower two-division simultaneous driving in FIG. 14A, a relative position relation is the same between the subjects of the left-eye image and the right-eye image without dependence on the screen upper portion and the screen lower portion. FIG. 14B is an expanded diagram illustrating the left-eye images and the right-eye images of two frames in the upper and lower division simultaneous driving. This means that the subject in the screen upper portion and the subject in the screen lower portion is localized in the identical depth direction, as understood from the result shown in FIGS. 6 and 8B. Accordingly, the unevenness shown in FIG. 12A does not occur in the depth direction between the upper and lower portions of the screen.

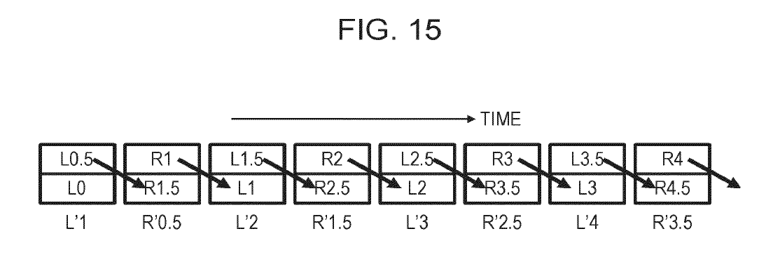

Further, the inventors suggest a display method of displaying a stereoscopic image in the upper and lower two-division driving in FIG. 15 instead of the display method shown in FIG. 3. According to the display method shown in FIG. 15, in the screen upper portion, 0.5 is subtracted from the sequence number n of the frame for the left-eye image L. In the screen lower portion, 0.5 is subtracted from the sequence number n of the frame for the right-eye image R in comparison to the display method shown in FIG. 3. Accordingly, in the upper and lower two-division driving, a left-eye image L′n of an n-th frame includes a screen upper portion of a left-eye interpolated image L(n−0.5) at the time before 0.5 frame and a screen lower portion of an original left-eye image L(n−1) at the time before one frame. Further, the right-eye image R′n of the n-th frame includes a screen upper portion of an original right-eye image Rn at the identical time and a screen power portion of a right-eye interpolated image R(n−0.5) of the time before 0.5 frame. According to the display method shown in FIG. 15, the upper image of an input image at a given time is first displayed, and then the lower image of the input image is displayed in the subsequent frame, as in the upper and lower two-division simultaneous driving method shown in FIG. 2.

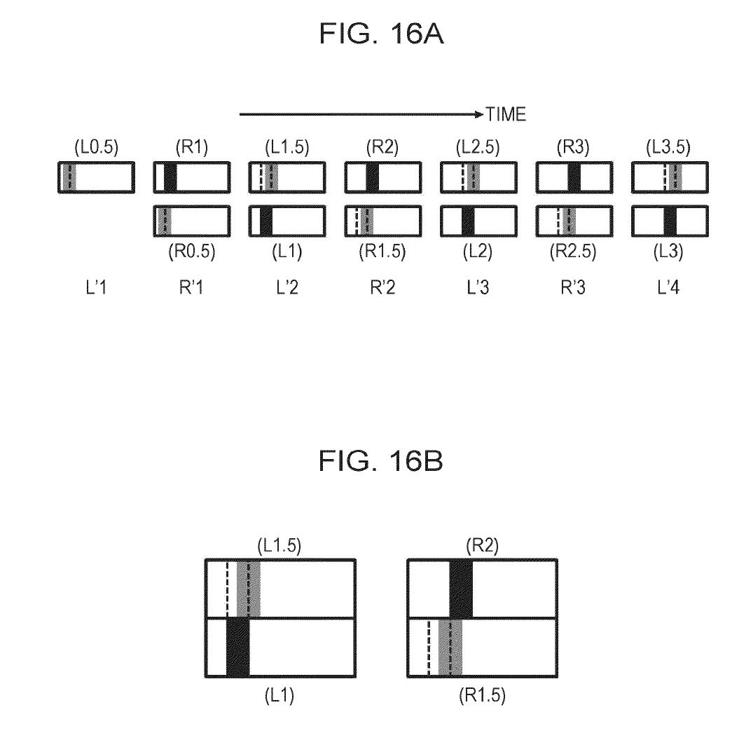

As shown in FIG. 9, the case will be described in which a subject is moving from the left side to the right side over time. Here, the subject is moving from the left side to the right side on the surface of the display panel and the subject of a left-eye image and the subject of a right-eye image are originally present at the identical position (which is described above). FIG. 16A shows the subjects of the left-eye image and the right-eye image displayed in accordance with the display method of displaying the stereoscopic image shown in FIG. 15.

According to the display method shown in FIG. 15, in the upper and lower two-division driving, the left-eye image L′n of the n-th frame includes the screen upper portion of the left-eye interpolated image L(n−0.5) at the time before 0.5 frame and a screen lower portion of an original left-eye image L(n−1) at the time before one frame. Further, the right-eye image R′n of the n-th frame includes the screen upper portion of the original right-eye image Rn at the identical time and the screen power portion of the right-eye interpolated image R(n−0.5) of the time before 0.5 frame. In FIG. 16A, the subjects of the input images Ln and Rn are indicated by black and the subjects of the interpolated images L(n−0.5) and R(n−0.5) are indicated by gray. The subjects shown in FIG. 10A are indicated by a dashed line to make a comparison.

When the left-eye image L′n and the right-eye image R′n are paired in the upper and lower two-division simultaneous driving in FIG. 16A, a relative position relation is the same between the subjects of the left-eye image and the right-eye image without dependence on the screen upper portion and the screen lower portion. FIG. 16B is an expanded diagram illustrating the left-eye images and the right-eye images of two frames in the upper and lower division simultaneous driving. This means that the subject in the screen upper portion and the subject in the screen lower portion is localized in the identical depth direction, as understood from the result shown in FIGS. 6 and 8B. Accordingly, the unevenness shown in FIG. 10A does not occur in the depth direction between the upper and lower portions of the screen.

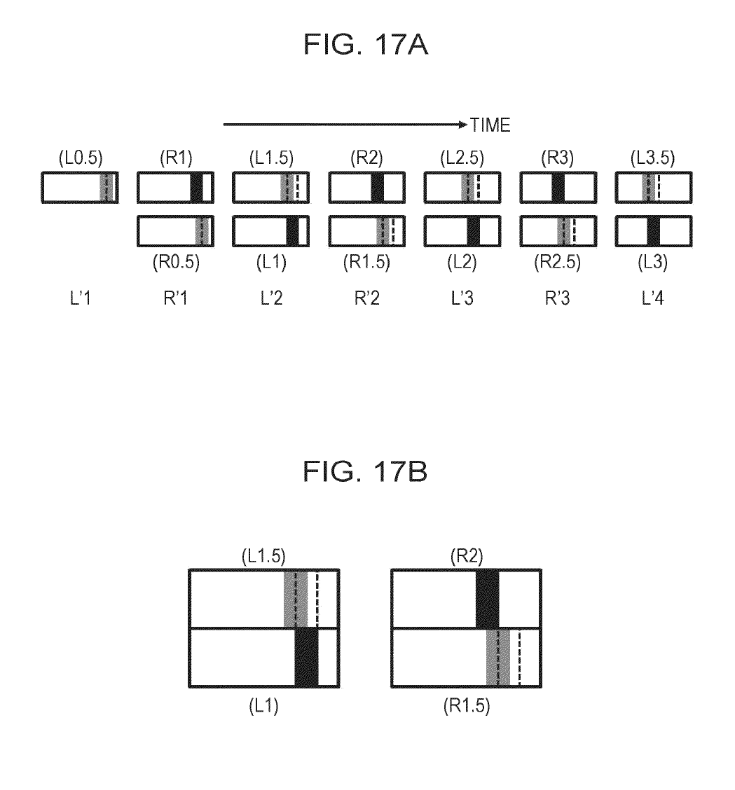

Subsequently, as shown in FIG. 11, the case will be described in which a subject is moving from the right side to the left side over time. Here, the subject is moving from the left side to the right side on the surface of the display panel and the subject of a left-eye image and the subject of a right-eye image are originally present at the identical position (which is described above). FIG. 17A shows the subjects of the left-eye image and the right-eye image displayed in accordance with the display method of displaying the stereoscopic image shown in FIG. 4. In FIG. 17A, the subjects of the input images Ln and Rn are indicated by black and the subjects of the interpolated images L(n−0.5) and R(n−0.5) are indicated by gray. The subjects shown in FIG. 12A are indicated by a dashed line to make a comparison.

When the left-eye image L′n and the right-eye image R′n are paired in the upper and lower two-division simultaneous driving in FIG. 17A, a relative position relation is the same between the subjects of the left-eye image and the right-eye image without dependence on the screen upper portion and the screen lower portion. FIG. 17B is an expanded diagram illustrating the left-eye images and the right-eye images of two frames in the upper and lower division simultaneous driving. This means that the subject in the screen upper portion and the subject in the screen lower portion is localized in the identical depth direction, as understood from the result shown in FIGS. 6 and 8B. Accordingly, the unevenness shown in FIG. 10A does not occur in the depth direction between the upper and lower portions of the screen.

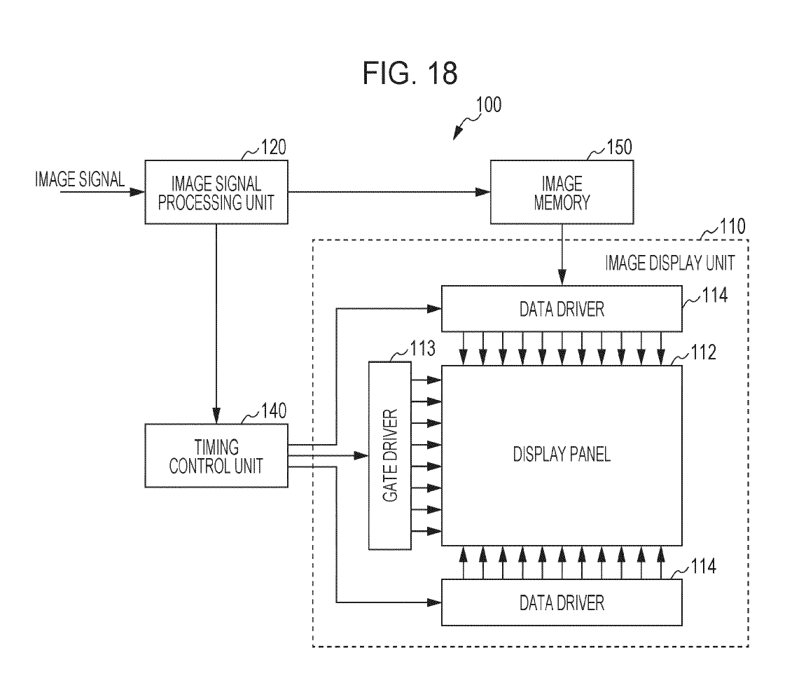

FIG. 18 is a diagram illustrating an example of the configuration of a display apparatus 100 capable of displaying a stereoscopic image by the upper and lower two-division simultaneous driving.

The display apparatus 100 includes an image display unit 110, an image signal processing unit 120, a timing control unit 140, and an image memory 150. The image display unit 110 includes a display panel 112, a gate driver 113, and data drivers 114.

When the image signal processing unit 120 receives an image signal from the outside of the image signal processing unit 120, the image signal processing unit 120 executes various signal processings so that the image signal is suitable for displaying a stereoscopic image in the image display unit 110, and then outputs the result to the image memory 150. Here, examples of the “outside” serving as a transmission source of the image signal include a digital broadcast receiver and a content item reproducing apparatus such as a Blu-ray disk player.

In this embodiment, the image signal processing unit 120 executes a frame interpolating process on the interpolated images L(n+0.5) and R(n+0.5) of a (n+0.5)-th frame, a process of separating the upper and lower portions of each image frame, a frame delaying process to realize the display method of displaying a stereoscopic image in the upper and lower two-division simultaneous driving described with reference to FIG. 4 or 15. The details will be described later.

The image signal processing unit 120 supplies a predetermined control signal to the timing control unit 140 in synchronization with a conversion timing of an image signal for the stereoscopic image to the timing control unit 140 so that the gate driver 113 and the data drivers 114 operate.

The gate driver 113 is a driving circuit that drives a gate bus line (not shown) of the display panel 112 and outputs a driving voltage, which is based on the image signal read from the image memory 150, to the gate bus line connected to each pixel in the display panel 112 in accordance with a signal from the timing control unit 140. In this embodiment, the gate driver 113 vertically divides the display panel 112 into two portions and simultaneously drives the screen upper portion and the screen lower portion.

The data driver 114 is a driving circuit that generates signals used to sequentially drive the respective pixels of the display panel 112 along data lines (scanning lines) (not shown) and outputs signals to be applied to the data lines in accordance with the signals transmitted from the timing control unit 140. For example, the data drivers 114 are disposed above and below the display panel 112, as shown in the drawing, and are configured to simultaneously output the signals from the upper and lower sides.

The display panel 112 has the plurality of pixels arranged in, for example, a lattice shape, but the embodiment of the present disclosure is not limited to the specific arrangement of the pixels. In a case of a liquid crystal pane, liquid crystal molecules having a predetermined alignment state are sealed between transparent plates such as glass, so that an image can be displayed by applying a signal from the outside. As described above, the gate driver 113 and the upper and lower data drivers 114 apply the signal to the display panel 112.

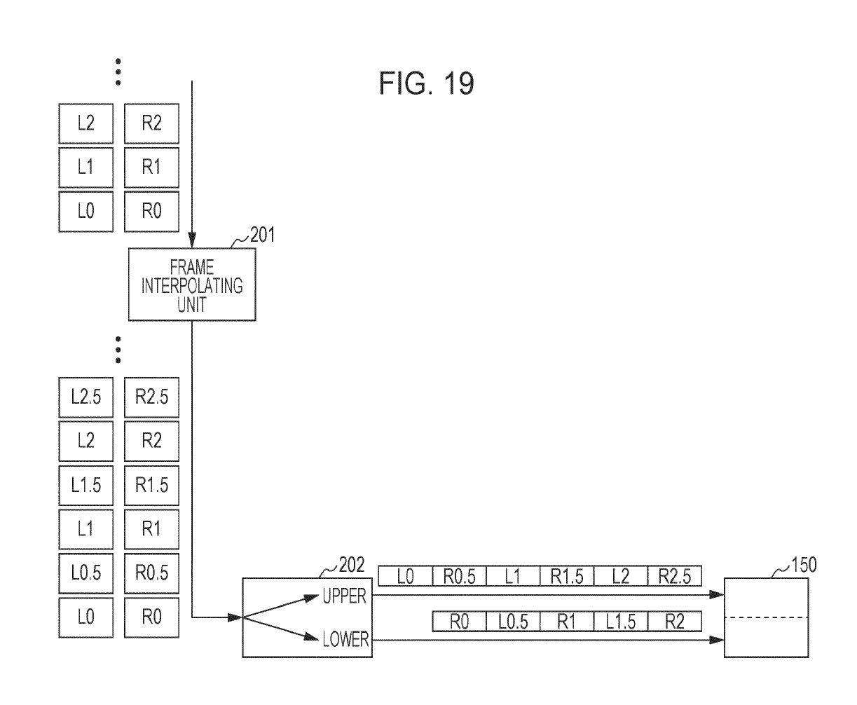

FIG. 19 is a diagram schematically illustrating the functional configuration of the image signal processing unit 120 configured to realize the display method of displaying a stereoscopic image in the upper and lower two-division simultaneous driving shown in FIG. 4.

Signals L0, R0, L1, R1, L2, R2, and the like for left-eye images and right-eye images are supplied to the image signal processing unit 120 from the outside in a frame sequence number order. The frame sequence number indicates the display order on a time axis.

The frame interpolating unit 201 generates left-eye interpolated images L0.5, L1.5, L2.5, and the like by adding 0.5 to the left-eye image L in a frame sequence number n and generates right-eye interpolated images R0.5, R1.5, R2.5, and the like by adding 0.5 to the right-eye image R in the frame sequence number n. The left-eye interpolated image L(n+0.5) is an image interpolated temporally in the center between a left-eye image Ln of an n-th frame and a left-eye image L(n+1) of an (n+1)-th frame. The left-eye interpolated image L(n+0.5) can be generated by a method or the like of interpolating the left-eye images Ln and L(n+1). The same is applied to a right-eye interpolated image R(n+0.5).

An upper lower separation delay unit 202 separates each image frame into an upper-half signal for the screen upper portion and a lower-half signal for the screen lower portion, when the input image frames and the interpolated image frames L0, L0.5, R0, R0.5, L1, L1.5, R1, R1.5, and the like interpolated by the frame interpolating unit 201 are input in the left and right order and the order of the sequence number.

The upper lower separation delay unit 202 delays the lower-half signal for the left-eye image by the 0.5 frame period and outputs the delayed lower-half signal. The upper lower separation delay unit 202 also delays the upper-half signal for the right-eye image by the 0.5 frame period and outputs the delayed upper-half signal. As a result, the upper-half signal of the original left-eye image Ln at the identical time and the lower-half signal of the left-eye interpolated image L(n−0.5) at the time before the 0.5 frame are output as the left-eye image L′n of an n-th frame to the image memory 150 and are displayed on the display panel 112. Further, the upper-half signal of the right-eye interpolated image R(n+0.5) at the time after a 0.5 frame and the lower-half signal of the original right-eye image Rn at the identical time are output as the right-eye image R′n of the n-th frame to the image memory 150 and are displayed on the display panel 112.

When the left-eye image L′n and the right-eye image R′n are paired in the upper and lower two-division simultaneous driving, as described with reference to FIGS. 13A and 14A, the relative position relation is the same between the subjects of the left-eye image and the right-eye image without dependence on the screen upper portion and the screen lower portion. Further, the unevenness does not occur in the depth direction between the upper and lower portions of the screen.

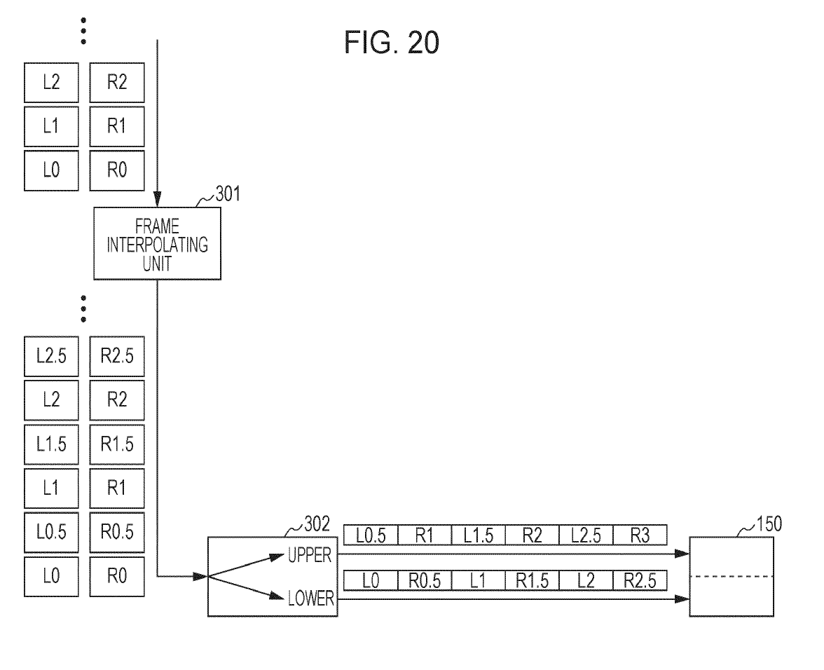

FIG. 20 is a diagram schematically illustrating the functional configuration of the image signal processing unit 120 configured to realize the display method of displaying a stereoscopic image in the upper and lower two-division simultaneous driving shown in FIG. 15.

Signals L0, R0, L1, R1, L2, R2, and the like for the left-eye image and the right-eye images are supplied to the image signal processing unit 120 from the outside in a frame sequence number order. The frame sequence number indicates the display order on a time axis.

A frame interpolating unit 301 generates left-eye interpolated images L0.5, L1.5, L2.5, and the like by adding 0.5 to the left-eye image L in a frame sequence number n and generates right-eye interpolated images R0.5, R1.5, R2.5, and the like by adding 0.5 to the right-eye image R in the frame sequence number n. The left-eye interpolated image L(n+0.5) is an image interpolated temporally in the center between a left-eye image Ln of an n-th frame and a left-eye image L(n+1) of an (n+1)-th frame. The left-eye interpolated image L(n+0.5) can be generated by a method or the like of interpolating the left-eye images Ln and L(n+1). The same is applied to a right-eye interpolated image R(n+0.5).

An upper lower separation delay unit 302 separates each image frame into an upper-half signal for the screen upper portion and a lower-half signal for the screen lower portion, when the input image frames and the interpolated image frames L0, L0.5, R0, R0.5, L1, L1.5, R1, R1.5, and the like interpolated by the frame interpolating unit 301 are input in the left and right order and the order of the sequence number.

The upper lower separation delay unit 302 delays the upper-half signal for the left-eye image by the 0.5 frame period and outputs the delayed upper-half signal. The upper lower separation delay unit 302 also delays the lower-half signal for the right-eye image by the 0.5 frame period and outputs the delayed lower-half signal. As a result, the upper-half signal of the left-eye image L(n−0.5) at the time before the 0.5 frame and the lower-half signal of the original left-eye interpolated image L(n−0.5) at the identical time are output as the left-eye image L′n of an n-th frame to the image memory 150 and are displayed on the display panel 112. Further, the upper-half signal of the original right-eye image Rn at the identical time and the lower-half signal of the right-eye interpolated image R(n−0.5) at the time before the 0.5 frame are output as the right-eye image R′n of the n-th frame to the image memory 150 and are displayed on the display panel 112.

When the left-eye image L′n and the right-eye image R′n are paired in the upper and lower two-division simultaneous driving, as described with reference to FIGS. 16A and 17A, the relative position relation is the same between the subjects of the left-eye image and the right-eye image without dependence on the screen upper portion and the screen lower portion. Further, the unevenness does not occur in the depth direction between the upper and lower portions of the screen.

The embodiment has hitherto been described in which the screen is vertically divided into two portions. However, frames of a left-eye image and a right-eye image at each time may be generated using an interpolated image, even when the screen is vertically divided into three portions. To increase the size of the display panel and improve a display speed, it can be supposed that the screen is divided into three or more portions. When the screen is divided into N portions, the screen of the left-eye image and the right-eye image is divided by N 1/N signals (here, N is an integer equal to or greater than 2), and left-eye images and right-eye images at respective times configured by the 1/N signal at the identical time and (N−1) interpolated images of which a time is deviated only by k/N frames at a position distant only by k/N frames in a vertical direction of the screen. For example, when N=4, each one screen of the left-eye image and the right-eye image is set as one screen formed by combining the input image at the identical time and three interpolated images deviated by only the 0.25 frame at each of four vertically divided positions.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display unit that displays an image;
an image signal processing unit that divides each of left-eye and right-eye images input in accordance with a frame sequential format into an upper-half signal of a screen upper portion and a lower-half signal of a screen lower portion and generates left-eye and right-eye images of the frame sequential format in upper and lower division simultaneous driving of a screen of the display unit so that the upper-half signal of the left-eye image and the lower-half signal of the right-eye image at each time become an input image at an identical time; and
a driving control unit that vertically divides the screen of the display unit into two portions and simultaneously drives the screen upper portion and the screen lower portion to display the left-eye and the right-eye images processed by the image signal processing unit.

2. The display apparatus according to claim 1, wherein the image signal processing unit sequentially generates a left-eye image L′n of an n-th frame, which includes the screen upper portion of an input left-eye image Ln at the identical time and the screen lower portion of a left-eye interpolated image L(n−0.5) at a time before a 0.5 frame, and a right-eye image R′n of the n-th frame, which includes the screen upper portion of a right-eye interpolated image R(n+0.5) at the time after a 0.5 frame and the screen lower portion of an input right-eye image Rn at the identical time, in the upper and lower division simultaneous driving.

3. The display apparatus according to claim 1, wherein the image signal processing unit sequentially generates a left-eye image L′n of an n-th frame, which includes the screen upper portion of a left-eye interpolated image L(n−0.5) at a time before a 0.5 frame and the screen lower portion of an input left-eye image L(n−1) at a time before one frame, in the upper and lower division simultaneous driving and a right-eye image R′n of the n-th frame, which includes the screen upper portion of an input right-eye image Rn at the identical time and the screen lower portion of a right-eye interpolated image R(n−0.5) at the time before a 0.5 frame, in the upper and lower division simultaneous driving.

4. A display apparatus comprising:
a display unit that displays an image;
an image signal processing unit that vertically divides a screen of each of left-eye and right-eye images input in accordance with a frame sequential format into N 1/N signals (where, N is an integer equal to or greater than 2) and generates left-eye and right-eye images at respective times configured by the 1/N signal at the identical time and (N−1) interpolated images of which a time is deviated by k/N frames at a position distant by k/N frames in a vertical direction of the screen; and
a driving control unit that vertically divides the screen of the display unit into two portions and simultaneously drives the screen upper portion and the screen lower portion to display the left-eye and the right-eye images processed by the image signal processing unit.
